(19) United States
(12) Patent Application Publication
(10) Pub. No.: US 2024/0095649 A1
(43) Pub. Date: Mar. 21, 2024

(54) DETERMINING ONE OR MORE TRACTOR UNITS FOR A TRACTOR-TRAILER

(71) Applicants: Marnix Lannoije, Altenberge (DE); Reinhard Beelmann, Haltern am See (DE); Andreas Schmitz, Münster (DE); Carsten Kaup, Coesfeld (DE)

(72) Inventors: Marnix Lannoije, Altenberge (DE); Reinhard Beelmann, Haltern am See (DE); Andreas Schmitz, Münster (DE); Carsten Kaup, Coesfeld (DE)

(73) Assignee: Schmitz Cargobull AG, Altenberge (DE)

(21) Appl. No.: 18/465,308

(22) Filed: Sep. 12, 2023

(30) Foreign Application Priority Data
Sep. 15, 2022 (EP) 22195917.4

(51) Int. Cl. G06Q 10/083

(52) U.S. Cl. CPC G06Q 10/083; B60L 53/62

(57) ABSTRACT

Disclosed is a method for determining one or more tractor units for a tractor-trailer in a system including a plurality of electrically driven tractor units. Each tractor unit is configured to form a tractor-trailer with a respective trailer and to tow the respective trailer. The method includes: receiving a first item of transport order information, representing a loading position and an unloading position, receiving first items of tractor unit information representing a current position of the respective tractor unit and an estimated current range of the respective tractor unit, determining the first tractor unit in order to form a first tractor-trailer for transporting the goods along a first section of a transport route, the determination of the first tractor unit being performed while considering the first item of transport order information and the first items of tractor unit information.

### CROSS-REFERENCE TO RELATED PATENT APPLICATIONS

This patent application claims priority to European Patent Application No. 22195917.4, filed Sep. 15, 2022, the entire teachings and disclosures of the aforementioned application is incorporated herein by reference thereto.

### FIELD

Exemplary embodiments of the invention relate to solutions for determining one or more tractor units for a tractor-trailer.

### BACKGROUND

Electrically driven tractor units which, with a trailer, form a tractor-trailer and can tow the trailer are known from the prior art. Such tractor-trailers can be used for example for transporting goods along a transport route (e.g. from a loading position to an unloading position). However, the range of such electrically driven tractor units is limited, so that, if a battery of the electrically driven tractor unit has to be charged one or more times during transport, the transport time can significantly increase in comparison with conventional tractor units with an internal combustion engine.

### SUMMARY OF THE INVENTION

It is therefore an object of the invention to overcome the aforementioned disadvantages.

According to the invention, a method for determining one or more tractor units for a tractor-trailer in a system comprising a plurality of electrically driven tractor units is disclosed, each tractor unit of the plurality of tractor units being configured to form a tractor-trailer with a respective trailer and to tow the respective trailer, the method comprising:
receiving a first item of transport order information of a first transport order, the first item of transport order information representing a loading position, at which a trailer is to be loaded with goods, and an unloading position, at which the goods are to be unloaded from the trailer,
receiving first items of tractor unit information, the first items of tractor unit information, at least for a first tractor unit of the plurality of tractor units, representing a current position of the respective tractor unit and an estimated current range of the respective tractor unit,
determining the first tractor unit from the plurality of tractor units in order to form a first tractor-trailer with the trailer for transporting the goods along a first section of a transport route, the determination of the first tractor unit from the plurality of tractor units being performed while taking into account the first item of transport order information and the first items of tractor unit information.

The disclosed method is for example at least partially performed by a server. The fact that the method is at least partially performed by a server should be understood as meaning for example that the server performs at least some of the steps of the method. In this case, the server should be understood as meaning (1) a server device (e.g. the server device disclosed below) or (2) a server cloud, comprising a number of server devices that cooperate with one another to perform the steps of the method, or (3) a virtual server. In this case, a server device should be understood as meaning a physical device with hardware components.

A server device is also disclosed, the server device comprising means configured for performing the disclosed method. The server device is for example a device for determining one or more tractor units for a tractor-trailer.

The means may comprise hardware components and/or software components. The means may for example comprise at least one memory with program instructions of a computer program (e.g. of the computer program disclosed below) and at least one processor configured for executing program instructions from the at least one memory. Accordingly, a server device comprising at least one processor and at least one memory with program instructions should also be understood as disclosed, the at least one memory and the program instructions being configured, together with the at least one processor, to cause the server device to perform the disclosed method.

Alternatively or in addition, the means may also comprise one or more communication interfaces (e.g. one or more wired and/or wireless communication interfaces, e.g. a wireless communication interface in the form of a radio interface) and/or one or more user interfaces (e.g. a keyboard, a mouse, a screen, a touch-sensitive screen, a speaker, a microphone, etc.). It should be understood that the disclosed server device may also comprise other, unlisted means.

A computer program is also disclosed, the computer program comprising program instructions which are configured, when executed by at least one processor, to cause a server (e.g., the disclosed server device) to perform the disclosed method.

The disclosed computer program is for example contained and/or stored on a computer-readable storage medium. A computer-readable storage medium should be understood as meaning for example a physical and/or tangible storage medium.

A system is also disclosed, the system comprising:
the disclosed server device;
a trailer; and
a plurality of tractor units, each tractor unit of the plurality of tractor units being configured to form a tractor-trailer with the trailer and to tow the trailer.

In the following, the characteristics of the disclosed method (hereinafter also referred to as the “method”), the disclosed server device (hereinafter also referred to as the “server device”), the disclosed computer program (hereinafter also referred to as the “computer program”) and the disclosed system (hereinafter also referred to as the “system”) are described—in part by way of examples. It goes without saying that the method, the server device, the computer program and the system correspond to one another, so that the disclosure of a feature for one of these categories should be understood as the disclosure of a corresponding feature for the other categories.

The system is for example a system for transporting goods.

In addition to the plurality of electrically driven tractor units, the system comprises for example a plurality of trailers.

An electrically driven tractor unit should be understood in particular as meaning a road vehicle driven by one or more electric motors. Such an electrically driven tractor unit has for example a battery for supplying the electric motor(s) with electrical energy, so that the respectively current range of the tractor unit can be estimated at least partially on the basis of the respectively current electrical energy stored in the battery.

At least part of the plurality of tractor units is for example unmanned and/or configured for semi-autonomous or autonomous driving. For example, this part of the plurality of tractor units comprises the first tractor unit disclosed above and/or the second tractor unit disclosed below. In other words, the first tractor unit and/or the second tractor unit may be unmanned and/or configured for semi-autonomous or autonomous driving.

In this case, semi-autonomous driving should be understood as meaning that the respective tractor unit automatically moves along part of a respective given route; and autonomous driving should be understood as meaning for example that the respective tractor unit automatically moves along the entire respective given route. For example, each tractor unit of this part of the plurality of tractor units may be configured to move automatically in given driving situations such as at low speeds (e.g. speeds not higher than 20 km/h or 10 km/h or 7 km/h) and/or in known environments (e.g. a depot and/or a goods/container handling station) and/or in driving situations of low complexity (e.g. on the highway) and to be controlled by a driver (e.g. on a remote control device) in other driving situations. For this purpose, each tractor unit of this part of the plurality of tractor units may comprise respective control means configured to control an automatic movement of the respective tractor unit, which are configured to control an automatic movement of the respective tractor unit along the respective given route or part of the respective given route, for example while taking into account items of environmental sensor information. The respective control means may respectively comprise hardware components and/or software components. The respective control means may for example comprise at least one memory with program instructions of a computer program and at least one processor configured for executing program instructions from the at least one memory. Accordingly, in particular, respective control means comprising at least one processor and at least one memory with program instructions should also be understood as disclosed, the at least one memory and the program instructions being configured, together with the at least one processor, to control the respective tractor unit during the semi-autonomous or autonomous driving.

An unmanned vehicle is, in particular, a vehicle which carries neither a driver nor one or more passengers and/or is configured for carrying a driver and one or more passengers. For example, an unmanned vehicle has no seat(s) for a driver and/or passenger(s).

A trailer should, in particular, be understood as meaning a commercial vehicle trailer for a road vehicle such as a rigid-drawbar trailer or an articulated-drawbar trailer or a semi-trailer. Such commercial vehicle trailers are intended in particular for transporting goods, preferably piece goods, in public road transport. For this purpose, commercial vehicle trailers have different types of commercial vehicle bodies, which serve for receiving the goods to be transported in a loading space. Known for example are box bodies with fixed side walls, a fixed front wall, a rear wall formed by wing doors and a fixed roof, which enclose the loading space. Since the box bodies are closed, box bodies are particularly suitable for the transport of moisture-sensitive and/or temperature-sensitive goods, i.e. for example for so-called dry transport and/or refrigerated transport. In addition to box bodies, also known are so-called tarpaulin bodies, in which the side walls and the roof are closed by at least one tarpaulin. In the case of tarpaulin bodies, the front wall is usually formed as a fixed wall, while the rear wall is regularly formed by two wing doors in order if required to load the loading space from the rear. If a tarpaulin can be moved along the side wall, they may also be referred to as curtainsiders. Accordingly, a commercial vehicle body should be understood as meaning for example a box body, a tarpaulin body and/or a curtainsider.

In order for the respective trailer to be able to form a tractor-trailer with a respective tractor unit, the respective trailer and the respective tractor unit have for example respective connecting means corresponding to one another, which are configured to establish a connection (e.g. a mechanical and/or electrical connection) between the respective trailer and the respective tractor unit. For example, the connecting means corresponding to one another comprise corresponding parts of a coupling system such as a fifth-wheel coupling, a bolt coupling or a ball-head coupling.

If the respective tractor unit is connected to the respective trailer (e.g. by the connecting means corresponding to one another disclosed above), the respective tractor unit and the respective trailer form for example a tractor-trailer (e.g. a truck-trailer and/or a semitrailer), so that the respective tractor unit tows the respective trailer.

Receiving one or more item(s) of information (e.g. an item of transport order information or items of tractor unit information) should be understood as meaning for example that the item(s) of information is/are received by a remote device via a communication link. Alternatively or in addition, one or more item(s) of information may also be received as a result of determining the item(s) of information. It goes without saying that one or more item(s) of information is/are also at least partially received, and at least partially determined, by a remote device via a communication link. For example, the first item of transport order information may be at least partially received, and at least partially determined, by a remote device.

A transport order is an order for transporting goods by a trailer from a loading position to an unloading position. Accordingly, an item of transport order information of such a transport order represents at least the loading position, at which the trailer is to be loaded with the goods, and the unloading position, at which the goods are to be unloaded from the trailer.

The first items of tractor unit information comprise at least one item of tractor unit information for the first tractor unit of the plurality of tractor units. In this case, an item of tractor unit information for a tractor unit of the plurality of tractor units should represent a current position of the respective tractor unit and an estimated current range of the respective tractor unit.

For example, each of the tractor units of the plurality of tractor units is configured to provide a respective item of tractor unit information (e.g. at regular time intervals and/or at given points in time) (e.g. to generate it and send it to the device(s) performing the disclosed method). Accordingly, the first items of tractor unit information for each of the tractor units of the plurality of tractor units may comprise a respective item of tractor unit information, representing the current position of the respective tractor unit and the estimated current range of the respective tractor unit.

The current position of the respective tractor unit should be understood as meaning for example the position of the respective tractor unit last detected by a position sensor of the respective tractor unit.

The estimated current range of the respective tractor unit should be understood as meaning for example the distance that the respective tractor unit can travel on the basis of the electrical energy currently stored in the battery of the respective tractor unit without the battery having to be charged. In order to estimate the current range of the respective tractor unit, the energy currently stored in the battery of the respective tractor unit can be determined at least partially on the basis of parameter(s) such as the battery voltage recently detected by one or more battery sensors. Then, the distance that the respective tractor unit can travel without the battery having to be charged can be determined on the basis of an average energy consumption of the respective tractor unit (e.g. the average energy consumption over a given period of time, such as since the battery was last charged, or the last 500 km or 250 km or 100 km traveled). The distance determined corresponds for example to the estimated current range of the respective tractor unit. It goes without saying that the invention is not restricted to this example for estimating the current range of the respective tractor unit.

Determining the first tractor unit from the plurality of tractor units should be understood as meaning for example that the first tractor unit is selected from the plurality of tractor units in order to form a first tractor-trailer with the trailer for transporting the goods along a first section of a transport route. The trailer may be for example a trailer intended for the transporting the goods. Alternatively, it may also be provided that the trailer is also determined for example from the plurality of trailers disclosed above. For example, determining the first tractor unit and/or the trailer may be performed according to given rules (e.g. according to a given algorithm such as a selection algorithm).

The determination of the first tractor unit from the plurality of tractor units should be performed while taking into account the first item of transport order information and the first items of tractor unit information. The first tractor unit may in this case be determined in such a way that given criteria are met and/or optimized in comparison with other tractor units of the plurality of tractor units. Examples of these criteria are (i) a distance between the loading position, represented by the first item of transport order information, and the current position of the first tractor unit, represented by the first items of tractor unit information, and/or (ii) the estimated current range of the first tractor unit, represented by the first items of tractor unit information.

The first section of the transport route starts for example at the loading position, i.e. the loading position corresponds to the starting position of the first section of the transport route. Accordingly, it may be advantageous to minimize the distance between the loading position, represented by the first item of transport order information, and the current position of the first tractor unit, represented by the first items of tractor unit information, when determining the first tractor unit from the plurality of tractor units, for example in order to minimize the energy consumption for the approach to the loading position, so that the tractor unit can tow the trailer as far as possible along the transport route without the battery of the first tractor unit having to be charged. In this case, the distance between the current position of the first tractor unit and the loading position should be understood as meaning for example the length of a route (e.g. the shortest or fastest route) between the current position of the first tractor unit and the loading position.

Alternatively or in addition, it may be advantageous to maximize the distance the first tractor unit can travel on the transport route without the battery of the first tractor unit having to be charged when determining the first tractor unit from the plurality of tractor units, e.g. to minimize the transport time. The distance the first tractor unit can travel on the transport route without the battery of the first tractor unit having to be charged can be determined for example on the basis of the estimated current range of the first tractor unit, represented by the first items of tractor unit information. For example, the distance the first tractor unit can travel on the transport route without the battery of the first tractor unit having to be charged corresponds to the estimated current range of the first tractor unit, represented by the first items of tractor unit information, minus the distance between the loading position, represented by the first item of transport order information, and the current position of the first tractor unit, represented by the first item of tractor unit information.

The invention thus provides a solution that allows a tractor unit that can tow as far as possible along the transport route without the battery of the first tractor unit having to be charged to be determined as the first tractor unit. This is particularly advantageous to keep the transport time as low as possible.

Further advantages of the disclosed invention are described below with reference to exemplary embodiments of the disclosed method, the disclosed computer program, the disclosed device and the disclosed system.

In exemplary embodiments, the determination of the first tractor unit from the plurality of tractor units comprises the determination of the first section of the transport route and/or the transport route.

For example, the transport route runs from the loading position to the unloading position. For example, the transport route from the loading position to the unloading position may be determined according to given rules such as an algorithm (e.g. a given route algorithm, e.g. a route algorithm for determining the fastest or shortest route).

For example, the starting position of the first section of the transport route corresponds to the loading position and the end position of the first section is located for example at a first charging point or in the vicinity (e.g. within a radius of less than 20 km, 10 km or 5 km) of the first charging point, the first charging point being configured to be connected to the first tractor unit to charge the battery of the first tractor unit. For example, the first section of the transport route may be determined in such a way (e.g. according to given rules such as an algorithm, e.g. a route algorithm) that the estimated current range of the first tractor unit, represented by the first items of tractor unit information (e.g. with a given minimum probability) is sufficient to cover a distance (i) from the current position of the first tractor unit, represented by the first items of tractor unit information, to the starting position of the first section and (ii) from the starting position of the first section along the transport route to the end position of the first section of the transport route and (iii) from the end position of the first section of the transport route to the first charging point without the battery of the first tractor unit having to be charged.

In exemplary embodiments, the disclosed method also comprises:
receiving second items of tractor unit information, the second items of tractor unit information, at least for a second tractor unit of the plurality of tractor units, representing a current position of the respective tractor unit and an estimated current range of the respective tractor unit,
determining the second tractor unit from the plurality of tractor units in order to form a second tractor-trailer with the trailer for transporting the goods along a second section of the transport route, the determination of the second tractor unit from the plurality of tractor units being performed while taking into account the first item of transport order information and the second items of tractor unit information.

The receiving of second items of tractor unit information and the determining of the second tractor unit from the plurality of tractor units are performed for example after determining the first tractor unit from the plurality of tractor units.

For example, the receiving of second items of tractor unit information and the determining of the second tractor unit from the plurality of tractor units are performed while the first tractor-trailer is moving along the transport route and/or the first section of the transport route. This may be the case in particular if the transport route and/or the first section of the transport route changes, e.g. because the actual range of the first tractor unit is less than the estimated current range of the first tractor unit, represented by the first items of tractor unit information, and/or if an estimated current range of the first tractor unit, represented by the second items of tractor unit information, is below a given minimum range.

The second items of tractor unit information comprise at least one item of tractor unit information for the second tractor unit of the plurality of tractor units. The second items of tractor unit information may also comprise an item of tractor unit information for the first tractor unit of the plurality of tractor units.

As disclosed above, each of the tractor units of the plurality of tractor units may be configured to provide a respective item of tractor unit information (e.g. at regular time intervals and/or at given points in time) (e.g. to generate it and send it to the device(s) performing the disclosed method). Accordingly, the second items of tractor unit information for each of the tractor units of the plurality of tractor units may comprise a respective item of tractor unit information representing the current position of the respective tractor unit and the estimated current range of the respective tractor unit. The second items of tractor unit information may in this case be provided at a later point in time than the first items of tractor unit information.

Determining the second tractor unit from the plurality of tractor units should be understood as meaning for example that the second tractor unit is selected from the plurality of tractor units in order to form the second tractor-trailer with the trailer for transporting the goods along the second section of the transport route. The trailer of the first tractor-trailer and the second tractor-trailer is in this case identical.

The determination of the second tractor unit from the plurality of tractor units should be performed while taking into account the first item of transport order information and the second items of tractor unit information. The second tractor unit may in this case be determined in such a way that given criteria are met and/or optimized in comparison with other tractor units of the plurality of tractor units. Examples of these criteria are (i) a distance between the end position of the first section of the transport route and the current position of the second tractor unit, represented by the second items of tractor unit information, and/or (ii) the estimated current range of the second tractor unit, represented by the second items of tractor unit information, and/or (iii) a distance between the current position of the first tractor unit, represented by the second items of tractor unit information, and the current position of the second tractor unit, represented by the second items of tractor unit information.

The second section of the transport route starts for example at the end position of the first section of the transport route, i.e. the end position of the first section of the transport route corresponds to the starting position of the second section. Accordingly, it may be advantageous to minimize the distance between the end position of the first section and the current position of the second tractor unit, represented by the second items of tractor unit information, when determining the second tractor unit from the plurality of tractor units, e.g. to minimize the energy consumption. In this case, the distance between the current position of the second tractor unit and the end position of the first section of the transport route should be understood as meaning for example the length of a route (e.g. the shortest or fastest route) between the current position of the second tractor unit and the end position of the first section of the transport route.

Alternatively or in addition, it may be advantageous to maximize the distance the second tractor unit can travel on the transport route without the battery of the second tractor unit having to be charged when determining the second tractor unit from the plurality of tractor units, e.g. to minimize the transport time. The distance that the second tractor unit can travel on the transport route without the battery of the second tractor unit having to be charged, can be determined for example on the basis of the estimated current range of the second tractor unit, represented by the second items of tractor unit information. For example, the distance the second tractor unit can travel on the transport route without the battery of the second tractor unit having to be charged corresponds to the estimated current range of the second tractor unit, represented by the second items of tractor unit information, minus the distance between the end position of the first section and the current position of the second tractor unit, represented by the second items of tractor unit information.

Alternatively or in addition, it may be advantageous to minimize the distance between the current position of the first tractor unit, represented by the second items of tractor unit information, and the current position of the second tractor unit, represented by the second items of tractor unit information, when determining the second tractor unit from the plurality of tractor units, e.g. to minimize the energy consumption. This applies in particular if the determination of the second tractor unit is performed because the estimated current range of the first tractor unit, represented by the second items of tractor unit information, is below a given minimum range. In this case, the distance between the current position of the second tractor unit and the current position of the first tractor unit should be understood as meaning for example the length of a route (e.g. the shortest or fastest route) between the current position of the second tractor unit and the current position of the first tractor unit.

For example, if the first tractor-trailer is broken up (e.g. by the connection between the first tractor unit and the trailer being released) before the second tractor-trailer forms. Then, the first tractor unit can for example move to a charging point and/or connect to the charging point to charge its battery.

By determining the second tractor unit, it is possible to avoid extending the transport time by the time it takes to charge the battery of the first tractor unit. Instead, the first tractor unit is replaced by the second tractor unit.

In exemplary embodiments, the determination of the second tractor unit from the plurality of tractor units comprises the determination of the second section of the transport route and/or the transport route. In this case, the determination of the transport route should be understood as also meaning for example the re-determination (e.g. updating) of the transport route if it has already been determined.

For example, the transport route runs from the loading position to the unloading position. For example, the transport route from the loading position to the unloading position can be determined (e.g. re-determined) (e.g. updated) according to given rules such as an algorithm (e.g. a given route algorithm, e.g. a route algorithm for determining the fastest or shortest route).

For example, the starting position of the second section of the transport route corresponds to the end position of the first section of the transport route and the end position of the second section is located for example at a second charging point or in the vicinity (e.g. within a radius of less than 20 km, 10 km or 5 km) of the second charging point, the second charging point being configured to be connected to the second tractor unit to charge the battery of the second tractor unit. For example, the second section of the transport route can be determined in such a way (e.g. according to given rules such as an algorithm, e.g. a route algorithm) that the estimated current range of the second tractor unit, represented by the second items of tractor unit information, (e.g. with a given minimum probability) is sufficient to cover a distance (i) from the current position of the second tractor unit, represented by the second items of tractor unit information, to the starting position of the second section and (ii) from the starting position of the second section along the transport route to the end position of the second section of the transport route and (iii) from the end position of the second section of the transport route to the second charging point without the battery of the second tractor unit having to be charged.

In exemplary embodiments, the first item of transport order information also represents:
a loading time and/or loading period; and/or
an unloading time and/or unloading period; and/or
a perishability and/or shelf-life and/or storability of the goods; and/or
a prioritization value for the transport of the goods from the loading position to the unloading position.

The loading time describes for example the time by which the trailer at the loading position should be loaded with the goods at the loading position and/or the first tractor-trailer should have left the first loading position (e.g. along the transport route in the direction of the unloading position); and the loading period describes for example the time period during which the trailer at the loading position should be loaded with the goods at the loading position and/or the first tractor-trailer should have left the first loading position (e.g. along the transport route in the direction of the unloading position). For example, the goods are ready for loading at the loading position by the loading time and/or during the loading period (e.g. as part of an automated loading process).

The unloading time describes, for example the time by which a tractor-trailer with the trailer (e.g. the second tractor-trailer) should arrive at the unloading position and/or the goods should be unloaded from the trailer at the unloading position; and the unloading period describes for example the time period during which a tractor-trailer with the trailer (e.g. the second tractor-trailer) should arrive at the unloading position and/or the goods should be unloaded from the trailer at the unloading position. For example, the goods are expected at the unloading position by the unloading time and/or during the unloading period (e.g. to be subsequently unloaded and/or further processed as part of an automated unloading and/or further processing process).

The indication of the loading time/loading period and/or the unloading time/unloading period is advantageous for example in order to be able to take these into account when determining the first and/or second tractor unit, so that deviations from this are avoided as far as possible.

The perishability and/or shelf-life and/or storability of the goods may be indicated for example in the form of a maximum transport period. Such a maximum transport period describes for example a maximum transport time from the loading position to the unloading position. If this maximum time is not exceeded, it is assumed for example that the goods have not spoiled during transport and/or that the transport has no undesirable negative effect on the shelf-life and/or storability of the goods. It goes without saying that different maximum transport periods can also be specified for different transport conditions (e.g. for different items of sensor information such as loading space temperature) and/or minimum transport conditions (e.g. in the form of lower and/or upper limit values for certain items of sensor information such as loading space temperature). This is advantageous for example in order to be able to take into account the perishability and/or shelf-life and/or storability of the goods when determining the first and/or second tractor unit.

The prioritization value for the transport of the goods from the loading position to the unloading position describes for example the prioritization of the first transport order for transporting the goods from the loading position to the unloading position in comparison with competing transport orders. The prioritization value for the transport of the goods, represented by the first item of transport order information, is specified for example by the customer. This is advantageous for example in order to be able to resolve conflicts in determining a tractor unit when the same tractor unit is considered to fulfill competing transport orders. For example, the prioritization value can only assume two values, prioritized and not prioritized. It is however also conceivable that the prioritization value can assume different values on a prioritization scale (e.g. from 1 (no prioritization) to 5 (high prioritization)).

The loading time/loading period and/or the unloading time/unloading period and/or the perishability and/or shelf-life and/or storability of the goods in the form of a maximum transport period may be taken into account when determining the first and/or second tractor unit. For example, a tractor unit may be determined as the first and/or second tractor unit, which for example is not immediately available (e.g. because it is further away and/or its battery still needs to be charged further), if the associated delay does not preclude the transport of the goods from the loading position to the unloading position in the time period described by the loading time/loading period and the unloading time/unloading period for transporting of the respective goods along the respective transport route and/or if the transport time of the goods does not thereby exceed the maximum transport period.

In exemplary embodiments, a prioritization value for the transport of the goods from the loading position to the unloading position is determined while taking into account an item of sensor information, the item of sensor information representing a parameter detected by a sensor of the trailer, in particular a parameter that is characteristic of a current and/or future expected condition of goods and is detected by the sensor of the trailer.

As disclosed above, the prioritization value for the transport of the goods from the loading position to the unloading position describes for example a prioritization of the first transport order for transporting the goods from the loading position to the unloading position in comparison with competing transport orders. For example, the prioritization value can only assume two values, prioritized and not prioritized. It is however also conceivable that the prioritization value can assume different values on a prioritization scale (e.g. from 1 (no prioritization) to 5 (high prioritization)).

For example, a parameter range in which the parameter detected by the sensor is located may be specified for the goods. As soon as the parameter detected by the sensor is outside this parameter range specified for the goods, it is assumed for example that the current and/or future expected condition of the goods will deteriorate. Accordingly, the prioritization value may in this case (i.e. if the parameter detected by the sensor lies outside the parameter range specified for the goods) be determined in such a way that the transport of the goods from the loading position to the unloading position, i.e. the first transport order, is prioritized over other competing transport orders.

A parameter characteristic of a current and/or future expected condition of the goods detected by the sensor of the trailer is for example a loading space temperature (e.g. for refrigerated goods) and/or a gas concentration (e.g. an ethylene gas concentration for fruit or vegetable products). For refrigerated goods, it is possible for example to specify a loading space temperature range in excess of which the refrigerated goods perish more quickly, such that the future expected condition of the goods deteriorates. Likewise, exceeding a specified ethylene gas concentration range for fruit or vegetable products may indicate an undesirable faster ripening of the fruit or vegetable products, such that the future expected condition of the goods deteriorates. In order to counteract the deterioration of the future condition of the goods, the prioritization value may in these cases be determined in such a way that the transport of the goods from the loading position to the unloading position, i.e. the first transport order, is prioritized over other competing transport orders.

Accordingly, the method may comprise at least one of the following steps:
acquiring and/or receiving the item of sensor information; and/or
determining the prioritization value for the transport of the goods from the loading position to the unloading position.

The determination of the first and/or second tractor unit may be performed while taking into account the prioritization value for the transport of the goods from the loading position to the unloading position.

For example, the first item of transport order information may be part of a plurality of items of transport order information of competing transport orders. In this case, transport orders should for example be understood as competing if the same tractor unit is considered for fulfilling the transport orders and/or if the loading times/loading periods and unloading times/unloading periods, represented by the respective items of transport order information of the competing transport orders, describe partly overlapping time periods for the transport of the respective goods along the respective transport route.

Each of these items of transport order information of the plurality of items of transport order information of competing transport orders may for example represent a respective prioritization value. Alternatively or in addition, a respective prioritization value may also be determined for each of the competing transport orders.

Furthermore, the determination of the first and/or second tractor unit may be performed while taking into account (i) the prioritization values represented by the plurality of items of transport order information of competing transport orders and/or (ii) the respective prioritization values determined for the competing transport orders. For example, the determination of the first and/or second tractor unit may be performed according to an auction algorithm based on the prioritization values. For example, the auction algorithm may receive the prioritization values as input values.

In exemplary embodiments, the system also comprises a plurality of charging points of an energy supply network, each tractor unit of the plurality of tractor units having a respective battery, and each charging point of the plurality of charging points being configured to be connected to a respective tractor unit of the plurality of tractor units in order to charge the respective battery of the respective tractor unit. For this purpose, the charging points support one or more charging standards such as Combined Charging System (CCS), Megawatt Charging System (MCS) and/or CHAdeMO. The specification and dissemination of the CCS charging standard is sponsored by CharIN e. V. and can currently be found at https://www.charin. global/. CharlN e. V. also supports the development of a specification of the MCS charging standard. The CHAdeMO charging standard is sponsored by the CHAdeMO Association and can currently be found at https://www.chademo.com/.

For example, the charging points may be at least partially located in different geographical positions. When determining the first and/or second tractor unit, the charging points of the plurality of charging points and/or their geographical positions may be taken into account. As disclosed above, the first section and the second section of the transport route may be determined in such a way that the end position of the first section is at a first charging point (i.e. the end position of the first section corresponds to the geographical position of the first charging point) or in the vicinity (e.g. within a radius of less than 20 km, 10 km or 5 km around the geographical position) of the first charging point and the end position of the second section is at a second charging point (i.e. the end position of the second section corresponds to the geographical position of the second charging point) or in the vicinity (e.g. within a radius of less than 20 km, 10 km or 5 km around the geographical position) of the second charging point. This is advantageous in particular to allow a charging of the battery of the first tractor unit by the first charging point and a charging of the battery of the second tractor unit at the second charging point.

Furthermore, at least some tractor units (e.g. each tractor unit) of the plurality of tractor units may be configured to provide the energy supply network with its respective battery for use as energy storage when the respective tractor unit is connected to a respective charging point of the plurality of charging points. For this purpose, the respective tractor units of the plurality of tractor units and the respective charging points of the plurality of charging points each support so-called bi-directional charging, i.e. on the one hand charging the battery of the respective tractor unit with electrical energy from the energy supply network connected to the respective charging point and on the other hand feeding back electrical energy stored in the battery of the respective tractor unit into the energy supply network connected to the respective charging point. Communication for bi-directional charging is standardized for example in the ISO 15118 standard of the International Electrotechnical Commission.

Bi-directional charging allows the battery of a respective tractor unit that is connected to a respective charging point to be used as flexible energy storage for the energy supply network. This is advantageous for example to temporarily store electrical energy generated by regenerative means at the respective charging point (e.g. by a wind turbine and/or a photovoltaic system) and to provide it to the energy supply network if required (e.g. at peak or maximum load times). In order to be able to take this into account when determining the first and/or second tractor unit, the method may also comprise:
receiving first items of energy storage demand information, the first items of energy storage demand information, at least for a first charging point of the plurality of charging points, representing a respective current and/or estimated future demand for the use of batteries of the plurality of tractor units as energy storage for the energy supply network at the respective charging point, the first charging point being connected to the first tractor unit in order to charge the battery of the first tractor unit, and the determination of the first tractor unit from the plurality of tractor units also being performed while taking into account the first items of energy storage demand information; and/or receiving second items of energy storage demand information, the second items of energy storage demand information, at least for a second charging point of the plurality of charging points, representing a respective current and/or estimated future demand for the use of batteries of the plurality of tractor units as energy storage for the energy supply network at the respective charging point, the second charging point being connected to the second tractor unit in order to charge the battery of the second tractor unit, and the determination of the second tractor unit from the plurality of tractor units also being performed while taking into account the second items of energy storage demand information.

The first items of energy storage demand information are received for example before determining the first tractor unit, and the second items of energy storage demand information are received for example before determining the second tractor unit. For example, the first tractor unit is connected to the first charging point when determining the first tractor unit and the second tractor unit is connected to the second charging point when determining the second tractor unit.

For example, the representation of the current and/or estimated future demand for the use of batteries of the plurality of tractor units as energy storage at the respective charging point by the first and/or second items of energy storage demand information comprises an energy storage capacity specification and a time specification, in particular a time period specification. For example, the energy storage capacity specification specifies which energy storage capacity is required at the respective charging point, and the time specification specifies for example the time period during which this energy storage capacity is required.

Alternatively or in addition, the first items of energy storage demand information may represent a prioritization value for the demand to use batteries of the plurality of tractor units as energy storage at the first charging point, and/or the second items of energy storage demand information may represent a prioritization value for the demand to use batteries of the plurality of tractor units as energy storage at the second charging point.

If the first tractor unit is connected to the first charging point and the first item of energy storage demand information represents for example a currently required energy storage capacity that can be covered by another tractor unit connected to the first charging point, this does not for example preclude the determination of the first tractor unit from the plurality of tractor units in order to form the first tractor-trailer with the trailer for the transport of the goods along the first section of the transport route, even taking into account the first item of energy storage demand information.

On the other hand, there may be a conflict if no other tractor unit is connected to the first charging point to cover the energy storage capacity currently required. Such a conflict can be resolved for example by comparing a prioritization value for the transport order, which, as disclosed above, can be represented and/or determined by the first item of transport order information, and the prioritization value for the demand to use batteries of the plurality of tractor units as energy storage at the first charging point. If the transport order is prioritized above the demand to use batteries of the plurality of tractor units as energy storage at the first charging point, the first tractor unit is nevertheless determined from the plurality of tractor units in order to form a first tractor-trailer with the trailer for transporting the goods along a first section of a transport route.

In exemplary embodiments, the tractor units are at least partially located at different geographical positions.

In exemplary embodiments, the method also comprises:
making the first tractor unit of the plurality of tractor units form the first tractor-trailer with the trailer for transporting the goods along the first section of the transport route; and/or
making the second tractor unit of the plurality of tractor units form the second tractor-trailer with the trailer for transporting the goods along the second section of the transport route.

In this case, “making” should be understood as meaning for example that the first tractor unit and/or the second tractor unit are controlled accordingly, e.g. by transmitting an item of control information to the first and/or second tractor unit.

In exemplary embodiments, the first and/or second items of tractor unit information are provided by the trailer. For example, the trailer sends the first and/or second items of tractor unit information via a communication link to a server (e.g., the server performing the method).

Further advantageous exemplary embodiments of the invention can be taken from the following detailed description of some exemplary embodiments of the present invention, in particular in conjunction with the figures. The figures are however only intended for the purpose of illustration, but do not serve for determining the scope of protection of the invention. The figures are not necessarily true to scale and are merely intended to reflect the general concept of the present invention by way of example. In particular, features which are included in the figures are in no way intended to be considered a necessary part of the present invention.

### BRIEF DESCRIPTION OF THE DRAWINGS

FIGS. 1a-c is a schematic representation of an exemplary embodiment of a system according to the invention;

FIG. 2 is a schematic representation of an embodiment of a server device according to the invention; and

FIG. 3 is a flow diagram of an embodiment of a method according to the invention.

### DETAILED DESCRIPTION

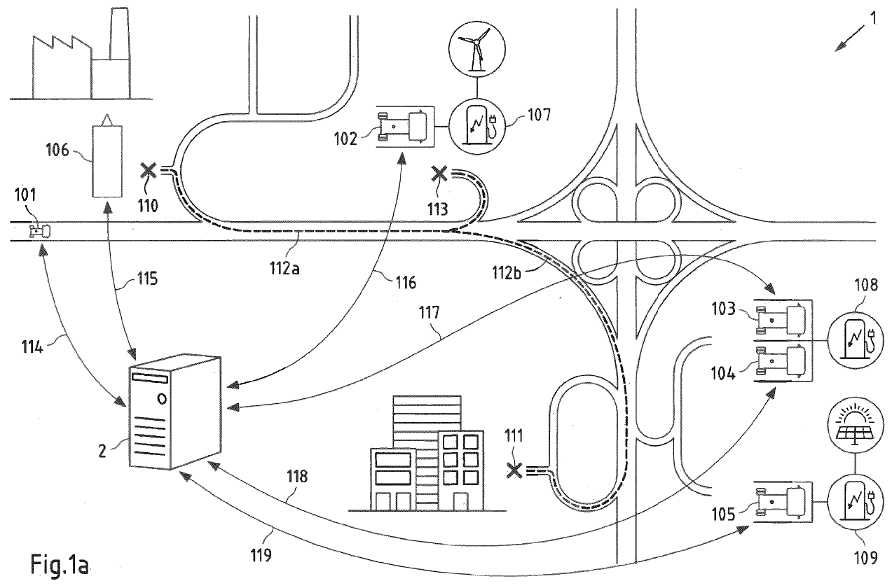

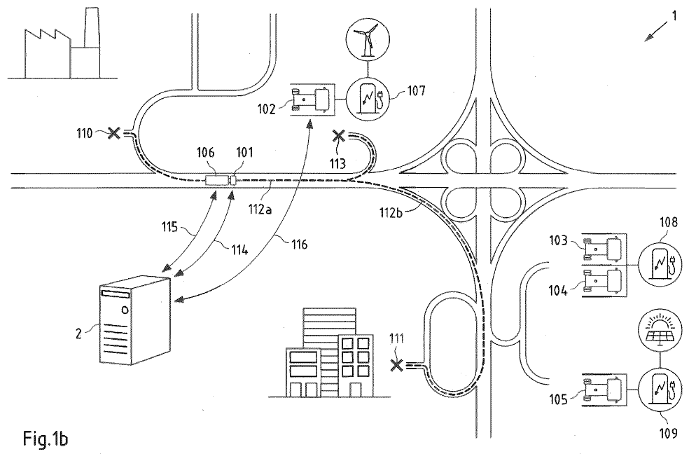

FIGS. 1a-c are a schematic representation of an exemplary embodiment of a system 1 according to the invention.

The system 1 comprises, inter alia, a plurality of electrically driven tractor units 101 to 105. Each of the tractor units 101 to 105 has a battery for supplying one or more electric motors that drive the respective tractor unit with electrical energy.

The tractor units 101 to 105 are shown in FIGS. 1a-c by way of example as semi-autonomous tractor units. In this case, a semi-autonomous tractor unit should be understood as meaning that the respective tractor unit automatically moves along a part of a respective given route (e.g. transport route 112a/b). For example, each tractor unit of this part of the plurality of tractor units 101 to 105 may be configured to move automatically in given driving situations such as at low speeds (e.g. speeds not higher than 20 km/h or 10 km/h or 7 km/h) and/or in known environments (e.g. a depot and/or a goods/container handling station) and/or in driving situations of low complexity (e.g. on the highway) and to be controlled by a driver (e.g. on a remote control device, not shown in FIGS. 1a-c) in other driving situations. For this purpose, each tractor unit of the plurality of tractor units 101 to 105 may comprise respective control means configured for controlling an automatic movement of the respective tractor unit, which are configured to control an automatic movement of the respective tractor unit along a part of the respective given route, for example while taking into account items of environmental sensor information. The respective control means may respectively comprise hardware components and/or software components. The respective control means may for example each comprise at least one memory with program instructions of a computer program and at least one processor configured for executing program instructions from the at least one memory. Accordingly, in particular, respective control means comprising at least one processor and at least one memory with program instructions should also be understood as disclosed, the at least one memory and the program instructions being configured, together with the at least one processor, to control the respective tractor unit during the semi-autonomous or autonomous driving.

Furthermore, the tractor units 101 to 105 are shown by way of example as unmanned vehicles which carry neither a driver nor one or more passengers and/or are configured for carrying a driver and one or more passengers. For example, the tractor units 101 to 105 have no seats for drivers and/or passengers.

The tractor units 101 to 105 are each configured to form a tractor-trailer with a respective trailer, such as the trailer 106, and to tow the respective trailer. The trailer 106 is shown in FIGS. 1a-c by way of example as a semi-trailer. Such commercial vehicle trailers are intended in particular for transporting goods, preferably piece goods, in public road transport. For this purpose, commercial vehicle trailers have different types of commercial vehicle bodies, which serve for receiving the goods to be transported in a loading space. Known for example are box bodies with fixed side walls, a fixed front wall, a rear wall formed by wing doors and a fixed roof, which enclose the loading space. Since the box bodies are closed, box bodies are particularly suitable for the transport of moisture-sensitive and/or temperature-sensitive goods, i.e. for example for so-called dry transport and/or refrigerated transport. In addition to box bodies, also known are so-called tarpaulin bodies, in which the side walls and the roof are closed by at least one tarpaulin. In the case of tarpaulin bodies, the front wall is usually formed as a fixed wall, while the rear wall is regularly formed by two wing doors in order if required to load the loading space from the rear. In order for the respective trailer to be able to form a tractor-trailer with a respective tractor unit, the respective trailer and the respective tractor unit have for example respective connecting means corresponding to one another, which are configured to establish a connection (e.g. a mechanical and/or electrical connection) between the respective trailer and the respective tractor unit.

Furthermore, the system 1 comprises a server device 2 remote from the tractor units 101 to 105 and the trailer 106.

In addition, the system 1 may comprise a plurality of charging points 107 to 109 of an energy supply network, each charging point of the plurality of charging points 107 to 109 being configured to be connected to a respective tractor unit of the plurality of tractor units 101 to 105 in order to charge the respective battery of the respective tractor unit.

It may be provided that at least some tractor units of the plurality of tractor units 101 to 105 are configured to provide the power supply network with its respective battery for use as energy storage when the respective tractor unit is connected to a respective charging point of the plurality of charging points 107 to 109. For this purpose, the respective tractor units of the plurality of tractor units 101 to 105 and the respective charging points of the plurality of charging points 107 to 109 can each support so-called bi-directional charging, i.e. on the one hand charging the battery of the respective tractor unit with electrical energy from the energy supply network connected to the respective charging point and on the other hand feeding back electrical energy stored in the battery of the respective tractor unit into the energy supply network connected to the respective charging point.

It goes without saying that the system 1 may comprise in addition to the tractor units 101 to 105 further tractor units and in addition to the trailer 106 further trailers (e.g. a plurality of trailers) and in addition to the charging points 107 to 109 further charging points.

The system 1 is for example a system for transporting goods. For example, goods are to be transported from a loading position 110 to an unloading position. An exemplary transport route 112a/b for transporting the goods from the loading position 110 to the unloading position 111 is also shown in FIGS. 1a-c. This transport route 112a/b has a first section 112a and a second section 112b. The starting position of the first section 112a corresponds to the loading position 110 and the end position of the first section corresponds to the geographical position 113 of the charging point 107; and the starting position of the second section 112b corresponds to the geographical position 113 of the charging point 107, i.e. the end position of the first section 112a, and the end position of the second section 112b corresponds to the unloading position 111.

The server device 2 can communicate with the tractor units 101 to 105 and the trailer 106 via the communication links 114 to 119, e.g. can receive and/or send information over the respective communication link. For example, each of the communication links 114 to 119 may comprise a respective connection via a cellular communication system such as a 2G/3G/4G/5G communication system. The specifications of the 2G, 3G, 4G or 5G cellular communication systems are developed by the 3rd Generation Partnership Project (3GPP) and are currently available on the Internet at https://www.3 gpp.org/.

It goes without saying that each of the communication links 114 to 119 may comprise in addition to the wireless connection via the cellular communication system also a wired connection via a wired communication network such as a local area network (Local Area Network, LAN), a wide area network (Wide Area Network) and/or the Internet. A local area network is for example an Ethernet that is specified in the IEEE 802.3 family of standards currently available on the Internet at https://standards.ieee.org/. The exchange of information via the communication links 114 to 119 may be encrypted.

For example, each of the tractor units of the plurality of tractor units 101 to 105 is configured to generate a respective item of tractor unit information (e.g. at regular time intervals and/or at given points in time) and to send it to the server device 2 via one of the communication links 114 to 119.

FIGS. 1a-c differ in that the tractor units 101 and 102 and also the trailer 101 are shown in different positions before and during the transport of the goods along the transport route 112a/b.

FIG. 1a shows a situation prior to the transport of the goods along the transport route 112a/b. In FIG. 1a, the trailer 106 is already at the loading position, but the first tractor unit 101 has not yet arrived at the loading position in order to form a tractor-trailer with the trailer 106.

In FIG. 1b, the first tractor unit 101 and the trailer 106 form a tractor-trailer and move for transporting the goods along the first section 112a of the transport route 112a/b.

In FIG. 1c, the second tractor unit 102 and the trailer 106 form a tractor-trailer and move for transporting the goods along the second section 112b of the transport route 112a/b.

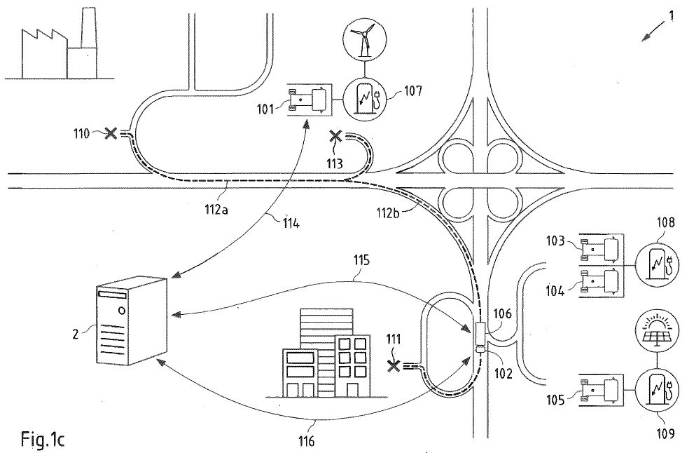

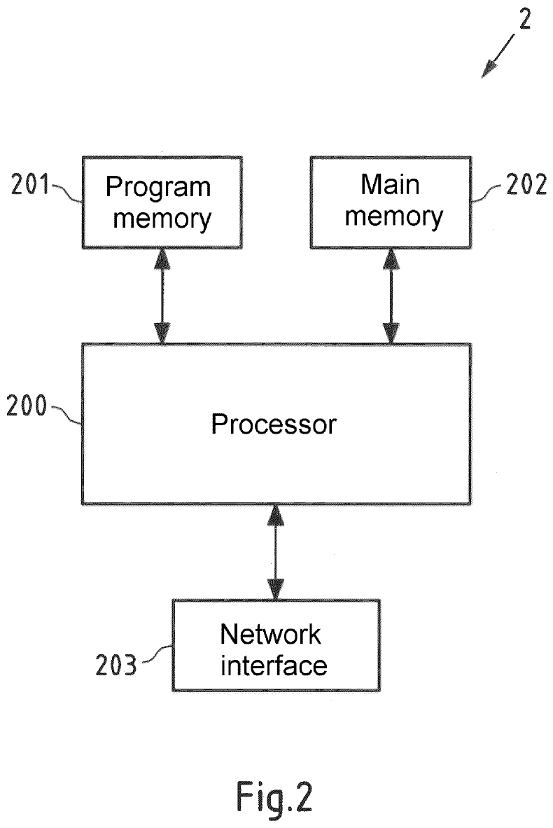

FIG. 2 shows a schematic representation of an embodiment of a server device 2 according to the invention. In the following, it is assumed for example that the server device 2 of the system 1 shown in FIG. 1 corresponds to this server device 2 shown in FIG. 2.

The server device comprises a processor 200 and, connected to the processor 200, a first memory as program memory 201, a second memory as main memory 202 and a network interface 203.

A processor should be understood as meaning for example a microprocessor (Central Processing Unit, CPU), a microcontroller, a digital signal processor (DSP), an application-specific integrated circuit (ASIC), a field programmable gate array (FPGA), or a graphical processor (Graphics Processing Unit (GPU). It goes without saying that the server device 2 may also comprise a number of processors 200.

Processor 200 executes program instructions stored in program memory 201, and stores for example intermediate results or the like in main memory 202. The use of an (additional) graphical processor may be advantageous for example for executing algorithms for machine learning and/or artificial neural networks.

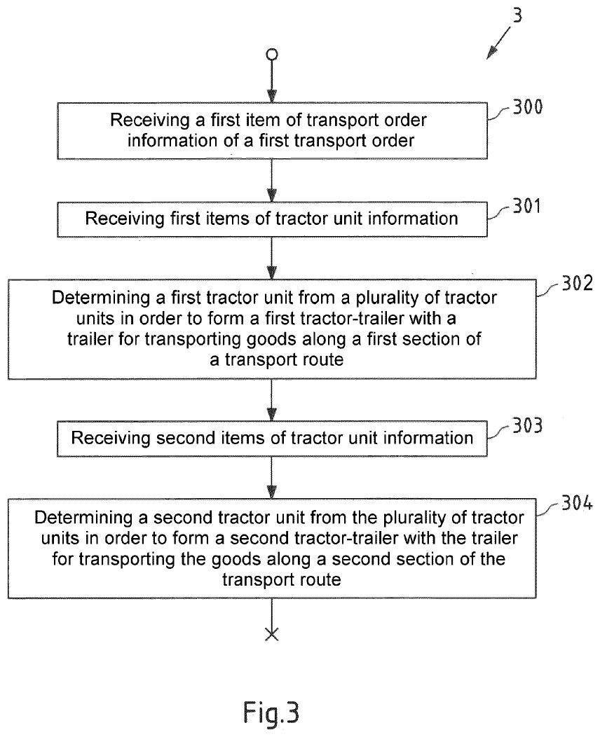

In program memory 201, there are stored for example program instructions, which cause the processor 200, when it executes the program instructions, to at least partially perform and/or control the method according to the invention (e.g. the method according to the flow diagram 3 shown in FIG. 3).

Program memory 201 also contains for example the operating system of the server device 2, which is at least partially loaded into main memory 202 when starting the server device 2 and executed by the processor 200. In particular, when starting the radio communication device 2, at least a part of the core of the operating system is loaded into the main memory 202 and executed by processor 200.

An example of an operating system is a Windows, UNIX, Linux, Android, Apple iOS and/or MAC OS operating system. The operating system allows in particular the use of the server device 2 for data processing. It manages for example operating means such as a main memory and a program memory, provides other computer programs with fundamental functions, inter alia by means of programming interfaces, and controls the execution of computer programs.

A program memory is for example a non-volatile memory such as a flash memory, a magnetic memory, an EEPROM memory (electrically erasable programmable read-only memory) and/or an optical memory. A main memory is for example a volatile or non-volatile memory, in particular a random access memory (RAM) such as a static RAM memory (SRAM), a dynamic RAM memory (DRAM), a ferroelectric RAM memory (FeRAM) and/or a magnetic RAM memory (MRAM).

Main memory 202 and program memory 201 may also be in the form of one memory. Alternatively, main memory 202 and/or program memory 201 may each be formed by a number of memories. Furthermore, main memory 202 and/or program memory 201 may also be part of the processor 200.

Processor 200 controls the network interface 203, which is configured for example to exchange (e.g. to send and/or receive) items of information with a remote device via a connection in a communication network. In the following, it is assumed for example that the network interface 203 is a wired network interface. An example of a wired network interface is an Ethernet interface. For example, the server device 2 can use the network interface 203 to exchange (e.g. to send and/or receive) items of information (e.g. items of tractor unit information) via the communication links 115 to 116 of the system 1 shown in FIG. 1.

The components 200 to 203 of the server device 2 are for example communicatively and/or operatively connected to one another via one or more bus systems (e.g. one or more serial and/or parallel bus connections).

It goes without saying that the server device 2 may comprise other components (e.g. a user interface) in addition to the components 200 to 203.

FIG. 3 shows a flow diagram 3 of an embodiment of a method according to the invention. In the following, it is assumed for example that steps 300 to 304 are performed by the server device 2 of the system 1 shown in FIG. 1.

In a step 300, a first item of transport order information of a first transport order is received, the first item of transport order information representing the loading position 110, at which the trailer 106 is to be loaded with goods, and the unloading position 111, at which the goods are to be unloaded from the trailer.

For example, the first item of transport order information comes from the server device of a customer, who orders the system 1 to transport the goods from the loading position 110 to the unloading position 111. For example, the first item of transport order information is received in step 300 by the server device 2 from the customer's server device via a communication link.

In a step 301, first items of tractor unit information are received, the first items of tractor unit information, at least for the first tractor unit 101 of the plurality of tractor units 101 to 105, representing a current position of the respective tractor unit and an estimated current range of the respective tractor unit.

As disclosed above, each of the tractor units of the plurality of tractor units 101 to 105 may be configured to generate a respective item of tractor unit information (e.g. at regular time intervals and/or at given points in times) and to send it to the server device 2 via one of the communication links 114 to 119. Accordingly, in the following it is assumed that the first items of tractor unit information for each of the tractor units of the plurality of tractor units 101 to 105 comprise a respective item of tractor unit information, representing the current position of the respective tractor unit and the estimated current range of the respective tractor unit. For example, the server device 2 receives the first items of tractor unit information in step 301 from the tractor units 101 to 105 via the communication links 114, 116 to 119.

The current position of the respective tractor unit, represented by the first items of tractor unit information, corresponds for example to the position of the respective tractor unit last detected by a position sensor of the respective tractor unit; and the estimated current range of the respective tractor unit, represented by the first items of tractor unit information, corresponds for example to the distance that the respective tractor unit can travel on the basis of the electrical energy currently stored in the battery of the respective tractor unit without the battery having to be charged. In order to estimate the current range of the respective tractor unit, the energy currently stored in the battery of the respective tractor unit can be determined at least partially on the basis of parameter(s) such as the battery voltage recently detected by one or more battery sensors. Then, the distance that the respective tractor unit can travel without the battery having to be charged can be determined on the basis of an average energy consumption of the respective tractor unit (e.g. the average energy consumption over a given period of time, such as since the battery was last charged, or the last 500 km or 250 km or 100 km traveled).

In a step 302, the first tractor unit 101 is determined from the plurality of tractor units 101 to 105 in order to form a first tractor-trailer with the trailer 106 for transporting the goods along the first section 112a of the transport route 112a/b, the determination of the first tractor unit 101 from the plurality of tractor units 101 to 105 being performed while taking into account the first item of transport order information and the first items of tractor unit information.

The determination of the first tractor unit 101 from the plurality of tractor units 101 to 105 should understood as meaning for example that the first tractor unit is selected from the plurality of tractor units in order to form a first tractor-trailer with the trailer 106 for transporting the goods along the first section 112a of the transport route 112a/b. For example, the first tractor unit 101 may be determined in such a way that given criteria are met and/or optimized in comparison with other tractor units of the plurality of tractor units 101 to 105. Examples of these criteria are (i) a distance between the loading position, represented by the first item of transport order information, and the current position of the first tractor unit, represented by the first items of tractor unit information, and/or (ii) the estimated current range of the first tractor unit, represented by the first items of tractor unit information.

The first section of the transport route starts for example at the loading position, i.e. the loading position corresponds to the starting position of the first section of the transport route. Accordingly, it may be advantageous to minimize the distance between the loading position, represented by the first item of transport order information, and the current position of the first tractor unit, represented by the first items of tractor unit information, when determining the first tractor unit from the plurality of tractor units, e.g. to minimize the energy consumption. In this case, the distance between the current position of the first tractor unit and the loading position should be understood as meaning for example the length of a route (e.g. the shortest or fastest route) between the current position of the first tractor unit and the loading position. For example, the current position of the first tractor unit in the situation shown in FIG. 1a is closest to the loading position 101.

Determining the first tractor unit in step 302 may also comprise determining the first section 112a of the transport route 112a/b. In the following, it is assumed for example that the first section 112a of the transport route 112a/b is determined in such a way (e.g. according to given rules such as an algorithm, e.g. a route algorithm) that the first section 112a of the transport route 112a/b ends at a charging point of the plurality of charging points 107 to 109 and the estimated current range of the first tractor unit, represented by the first items of tractor unit information (e.g. with a given minimum probability), is sufficient to cover a distance (i) from the current position of the first tractor unit, represented by the first items of tractor unit information, to the starting position 110 of the first section, and (ii) from the starting position 110 of the first section 112a along the transport route 112a/b to the end position 113 of the first section 112a of the transport route 112a/b without the battery of the first tractor unit 101 having to be charged. The starting position of the correspondingly determined first section 112a of the transport route 112a/b in FIGS. 1a-c corresponds to the loading position 110 and the end position 113 of the first section 112a is located for example at the first charging point 107.

If the first tractor unit 101 was determined from the plurality of tractor units 101 to 105 in step 301, the server device 2 may also make the first tractor unit 101 form the first tractor-trailer with the trailer 106 for transporting the goods along the first section of the transport route. For this purpose, the server device 2 may send a first item of control information to the tractor unit 101 via the communication link 114. For example, the first item of control information makes the tractor unit 101 move automatically to the loading position 110 and, when it has arrived at the loading position 110, form a tractor-trailer with the trailer 106 and then tow the trailer 106 along the first section 112a of the transport route 112a/b.

In a step 303, second items of tractor unit information are received, the second items of tractor unit information, at least for the first tractor unit 101 and the second tractor unit 102 of the plurality of tractor units 101 to 105, representing a current position of the respective tractor unit and an estimated current range of the respective tractor unit.

In the following, it is assumed that the second items of tractor unit information for each of the tractor units of the plurality of tractor units 101 to 105 comprise a respective item of tractor unit information, representing the current position of the respective tractor unit and the estimated current range of the respective tractor unit. For example, the server device 2 receives the second items of tractor unit information in step 301 from the tractor units 101 to 105 via the communication links 114, 116 to 119. The second items of tractor unit information differ from the first items of tractor unit information for example in that they were sent at a later point in time than the first items of tractor unit information and thus represent current positions and current estimated ranges at a later point in time. For example, the first items of tractor unit information represent the current positions and current estimated ranges in the situation shown in FIG. 1a, whereas the second items of tractor unit information represent the current positions and current estimated ranges in the situation shown in FIG. 1b.

Step 300 to step 302 are performed for example before the transport of the goods along the transport route 112a/b, for example in the situation shown in FIG. 1a; and steps 303 and 304 are performed for example during the transport of the goods on the first section 112a of the transport route 112a/b, for example in the situation shown in FIG. 1b, e.g. when the first tractor-trailer approaches the end position 113, e.g. when the distance between the current position of the first tractor unit 101, represented by the second items of tractor unit information, and the end position 113 falls below a distance threshold value (e.g. 50 km, 100 km, 200 km).

In a step 304, the second tractor unit 102 is determined from the plurality of tractor units 101 to 105 to form a second tractor-trailer with the trailer 106 for transporting the goods along the second section 112b of the transport route 112a/b, the determination of the second tractor unit 102 from the plurality of tractor units 101 to 105 being performed while taking into account the first item of transport order information and the second items of tractor unit information.

Determining the second tractor unit 102 from the plurality of tractor units 101 to 105 should be understood as meaning for example that the second tractor unit 102 is selected from the plurality of tractor units 101 to 105 to form the second tractor-trailer with the trailer 106 for transporting the goods along the second section 112b of the transport route 112a/b. The trailer 106 of the first tractor-trailer and the second tractor-trailer is in this case identical.

The second tractor unit 102, like the first tractor unit 101, may be determined in such a way that given criteria are met and/or are optimized in comparison with other tractor units of the plurality of tractor units 101 to 105. Examples of these criteria are (i) a distance between end position 113 of the first section 112a of the transport route 112a/b and the current position of the second tractor unit, represented by the second items of tractor unit information, and/or (ii) the estimated current range of the second tractor unit, represented by the second items of tractor unit information, and/or (iii) a distance between the current position of the first tractor unit, represented by the second items of tractor unit information, and the current position of the second tractor unit, represented by the second items of tractor unit information. For example, the current position of the second tractor unit 102 in the situation shown in FIG. 1b is at the end position 113 of the first section 112a of the transport route 112a/b.

Determining the second tractor unit in step 304 may also comprise determining the second section 112b of the transport route 112a/b. In the following, it is assumed for example that the second section 112bof the transport route 112a/b is determined in such a way (e.g. according to given rules such as an algorithm, e.g. a route algorithm) that the second section 112b of the transport route 112a/b starts at the end position 113 of the first section 112a of the transport route 112a/b and the estimated current range of the second tractor unit, represented by the second items of tractor unit information (e.g. with a given minimum probability), is sufficient to cover a distance (i) from the end position 113 of the first section 112a along the transport route 112a/b to the end position of the second section 112b of the transport route 112a/b without the battery of the second tractor unit 102 having to be charged. The starting position of the correspondingly determined second section 112b of the transport route 112a/b in FIGS. 1a-c corresponds to the end position 113 of the first section 112a of the transport route and the end position of the second section 112b corresponds to the unloading position 111.

If the second tractor unit 101 was determined from the plurality of tractor units 101 to 105 in step 304, the server device 2 may also make the second tractor unit 101 form the second tractor-trailer with the trailer 106 for transporting the goods along the second section 112b of the transport route 112a/b. For this purpose, the server device 2 may send a second item of control information to the tractor unit 101 via the communication link 116. For example, the second item of control information makes the tractor unit 102 be ready at the end position 113 and, when the trailer 106 arrives at the loading position 110, form a tractor-trailer with the trailer 106 and then tow the trailer 106 along the second section 112b of the transport route 112a/b.

The exemplary embodiments of the present invention described in this specification should also be understood as disclosed in all combinations with one another. In particular—unless explicitly stated to the contrary—the description of a feature covered by an embodiment should not be understood in the present case in such a way that the feature is indispensable or essential for the function of the exemplary embodiment. The sequence of the steps described in this specification in the individual flow diagrams is not mandatory; alternative sequences of the steps are conceivable—unless otherwise specified. The steps can be implemented in various ways, with software implementation (by program instructions), hardware implementation or a combination of both to implement the steps being conceivable.

Terms used in the claims such as “comprise”, “have”, “include”, “contain” and the like do not exclude other elements or steps. The wording “at least partially” covers both the “partially” case and the “completely” case. The wording “and/or” should be understood as meaning that both the alternative and the combination are intended to be disclosed, that is to say that “A and/or B” means “(A) or (B) or (A and B)”. Within the context of this specification, a plurality of units, persons or the like means a number of units, persons or the like. The use of the indefinite article does not exclude a plurality. A single component may perform the functions of several units or devices specified in the claims. The references given in the claims are not to be regarded as restrictions on the means and steps used.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for determining one or more tractor units for a tractor-trailer in a system comprising a plurality of electrically driven tractor units, each tractor unit of the plurality of tractor units being configured to form a tractor-trailer with a respective trailer and to tow the respective trailer, the method comprising:
receiving a first item of transport order information of a first transport order, the first item of transport order information representing a loading position, at which a trailer is to be loaded with goods, and an unloading position, at which the goods are to be unloaded from the trailer,
receiving first items of tractor unit information, the first items of tractor unit information, at least for a first tractor unit of the plurality of tractor units, representing a current position of the respective tractor unit and an estimated current range of the respective tractor unit,
determining the first tractor unit from the plurality of tractor units in order to form a first tractor-trailer with the trailer for transporting the goods along a first section of a transport route, the determination of the first tractor unit from the plurality of tractor units being performed while taking into account the first item of transport order information and the first items of tractor unit information.

2. The method as claimed in claim 1, the transport route running from the loading position to the unloading position, and/or the determination of the first tractor unit from the plurality of tractor units comprising the determination of the first section of the transport route and/or the transport route.

3. The method as claimed in claim 1, the method also comprising:
receiving second items of tractor unit information, the second items of tractor unit information, at least for the first tractor unit and a second tractor unit of the plurality of tractor units, representing a current position of the respective tractor unit and an estimated current range of the respective tractor unit,
determining the second tractor unit from the plurality of tractor units in order to form a second tractor-trailer with the trailer trailer for transporting the goods along a second section of the transport route, the determination of the second tractor unit from the plurality of tractor units being performed while taking into account the first item of transport order information and the second items of tractor unit information.

4. The method as claimed in claim 3, determination of the second tractor unit from the plurality of tractor units comprising the determination of the second section of the transport route and/or the transport route.

5. The method as claimed in claim 1, the first item of transport order information also representing:
a loading time and/or loading period; and/or
an unloading time and/or unloading period; and/or
a perishability and/or shelf-life and/or storability of the goods; and/or
a prioritization value for the transport of the goods from the loading position to the unloading position.

6. The method as claimed in claim 1, a prioritization value for the transport of the goods from the loading position to the unloading position being determined while taking into account an item of sensor information, the item of sensor information representing a parameter detected by a sensor of the trailer trailer, in particular a parameter that is characteristic of a current and/or future expected condition of goods and is detected by the sensor of the trailer.

7. The method as claimed in claim 6, the method comprising at least one of the following steps:
acquiring and/or receiving the item of sensor information; and/or
receiving and/or determining the prioritization value for the transport of the goods from the loading position to the unloading position.

8. The method as claimed in claim 5, the determination of the first tractor unit being performed while taking into account the prioritization value for the transport of the goods from the loading position to the unloading position.

9. The method as claimed in claim 8, the first item of transport order information being part of a plurality of items of transport order information of competing transport orders, and each of these items of transport order information of the plurality of items of transport order information of competing transport orders representing a respective prioritization value, and the determination of the first tractor unit being performed while taking into account the prioritization values represented by the plurality of items of transport order information of competing transport orders.

10. The method as claimed in claim 1, the system also comprising a plurality of charging points of an energy supply network, each tractor unit of the plurality of tractor units having a respective battery, and each charging point of the plurality of charging points being configured to be connected to a respective tractor unit of the plurality of tractor units in order to charge the respective battery of the respective tractor unit.

11. The method as claimed in claim 10, each tractor unit of the plurality of tractor units being configured to provide the energy supply network with its respective battery for use as energy storage when the respective tractor unit is connected to a charging point of the plurality of charging points, and the method also comprising:
receiving first items of energy storage demand information, the first items of energy storage demand information, at least for a first charging point of the plurality of charging points, representing a respective current and/or estimated future demand for the use of batteries of the plurality of tractor units as energy storage for the energy supply network at the respective charging point, the first charging point being connected to the first tractor unit in order to charge the battery of the first tractor unit, and the determination of the first tractor unit from the plurality of tractor units also being performed while taking into account the first energy storage demand information.

12. The method as claimed in claim 1, the first items of tractor unit information being provided by the trailer.

13. A computer program comprising program instructions which are configured, when executed by at least one processor of a server, to cause the server to perform the method as claimed in claim 1.

14. A server device comprising means configured for performing the method as claimed in claim 1.

15. A system comprising:
a server device as claimed in claim 14,
a trailer, and
a plurality of tractor units, each tractor unit of the plurality of tractor units being configured to form a tractor-trailer with the trailer and to tow the trailer.
